(19) United States
(12) Patent Application Publication
(10) Pub. No.: US 2007/0169473 A1
(43) Pub. Date: Jul. 26, 2007

(54) HYDRAULIC CIRCUIT

(75) Inventor: Hans Esders, Hildesheim (DE)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 11/616,313

(22) Filed: Dec. 27, 2006

(30) Foreign Application Priority Data
Jan. 24, 2006 (DE) 102006 003 414.7

(51) Int. Cl. F16D 31/02

(52) U.S. Cl. 60/422

(57) ABSTRACT

A hydraulic circuit arrangement with a fixed displacement pump driven by an electric motor, a lifting cylinder, a load-holding valve arranged in the line between pump and lifting cylinder, a priority valve, which is acted upon by the pump, being arranged between pump and load-holding valve and distributing the volumetric flow flowing from the pump to the lifting cylinder, on the one hand, and to at least one further consumer of a load-sensing system, on the other hand. In the first of its two extreme positions, the priority valve connects both the lifting cylinder and the at least one further consumer in each case to the pump and, in the second of its two extreme positions, only connects the at least one further consumer to the pump while the lifting cylinder is completely cut off.

### BACKGROUND OF THE INVENTION

The invention relates to a hydraulic circuit arrangement with a fixed displacement pump driven by an electric motor, and a lifting cylinder, where, in order to recuperate energy, the electric motor can be operated as a generator and the pump can be operated as a hydraulic motor in order to recuperate potential energy of the lifting cylinder, and with a load-holding valve arranged in the line between pump and lifting cylinder, in accordance with the precharacterizing clause of Claim 1.

A circuit arrangement of this type for battery-driven fork lift trucks is known from DE 43 17 782 C2. The principle is illustrated in FIG. 1: a DC or asynchronous electric motor M drives a pump P which provides the hydraulic pressure for the lifting cylinder HZ. A load-holding valve LHV is provided between pump P and lifting cylinder HZ and, in the “lifting” position illustrated in FIG. 1, contains a non-return valve RV which prevents the load from sagging after the end of the lifting operation. During lowering of the load, the load-holding valve LHV is being switched electrically into its open position, in which it permits the fluid to flow back from the lifting cylinder HV to the pump P virtually without any loss of pressure. In the process, potential energy stored in the lifting cylinder HZ is recuperated by the pump now operating as a hydraulic motor and the electric motor operating as a generator G to recharge the battery. The particular advantages consist in that the effort is relatively low and no inherent pressure losses occur.

If even more consumers and additional functions are provided in the case of the known arrangement, a further pump, for example, has to be provided therefore, or the lowering function has to be interrupted if the additional function is required.

The “Load-sensing System” (H. Ebertshäuser, S. Helduser: Fluidtechnik von A bis Z [A to Z of fluid technology], Vereinigte Fachverlage Mainz, 2nd edition, 1995, p. 221, 222) is suitable for supplying a plurality of consumers. A hydraulic control system of this type with pressure and volume adaptation to the current requirements of the consumers can be realized both with a variable displacement pump and with a fixed displacement pump. FIG. 2 shows an embodiment of a modified load-sensing system LSS with a fixed displacement pump P which is driven by an electric motor M which can be varied in rotational speed. A prerequisite is that, for the control, the volumetric flow requirements of all of the consumers are known. The desired pressure level or the desired volumetric flow requirement is not controlled via the pivoting angle of a variable displacement pump but rather via the rotational speed of the fixed displacement pump P. Given moderate requirements for accuracy, this control can take place without additional sensors, with it being possible for the pressure to be estimated via the electric current flowing to the motor. The volumetric flow is proportional to the rotational speed. The pressure-dependent leakage can be included via the estimated pressure.

The division of the volumetric flow to the individual consumers (cylinders Z1, Z2) with their different pressure levels take place in a known manner using individual pressure balances (DW1, DW2) downstream of which the directional control valves V1, V2 are connected. WV refers to the shuttle valve which usually serves to forward the maximum pressure to the pump control but is no longer required for this purpose if the volumetric flow is already controlled by the motor control system.

The circuit illustrated in FIG. 2 could theoretically be expanded in such a manner that one of the cylinders Z1, Z2 is the one required for recuperating energy. This solution would not be ideal in terms of energy, since the load-sensing principle is dependent on a significant difference in pressure in the feed to each consumer. Furthermore, it is required to arrange the pressure balances on the same side of the orificing point in each case. Since, when the load is lowered, the direction of the volumetric flow is reversed, either the sequence of pressure balance and directional control valve would have to be reversed or a second orificing point would have to be provided, which is associated with further losses. In addition, further valves would be required so that the pressure balance is in each case assigned to the correct orificing point.

### SUMMARY OF THE INVENTION

The invention is based on the object of indicating a circuit for feeding back energy from a lifting cylinder during simultaneous operation with other consumers.

According to the invention, the object is achieved in the case of a hydraulic circuit arrangement according to the precharacterizing clause of Claim 1 by a priority valve which is acted upon by the pump, being arranged between pump and load-holding valve and distributing the volumetric flow flowing from the pump to the lifting cylinder, on the one hand, and to at least one further consumer of a load-sensing system, on the other hand, in the first of its two extreme positions, the priority valve connecting both the lifting cylinder and the at least one further consumer in each case to the pump, and, in the second of its two extreme positions, the priority valve only connecting the at least one further consumer to the pump while the lifting cylinder is completely cut off.

### BRIEF DESCRIPTION OF THE DRAWINGS

FIG. 1 is a schematic of a circuit arrangement for a battery-driven forklift truck;

FIG. 2 is a schematic of a circuit arrangement;

FIG. 3 is a schematic of an alternative circuit arrangement; and

FIG. 4 is a schematic of an alternative circuit arrangement.

### DETAILED DESCRIPTION OF THE PREFERRED EMBODIMENTS

Priority valve is understood here as meaning a proportional servo valve, the sliding member of which is acted upon from both sides by different pressures. It has the object of distributing the volumetric flow flowing into the lifting cylinder, on the one hand, and to the further consumers, on the other hand, with in each case a minimal loss of pressure. The advantage resides in the fact that, at least during individual operation of the lifting cylinder, a fundamental drop in pressure does not occur. If there are no further consumers, the drop in pressure is reduced to the extent which is unavoidable on account of the structural configuration of the priority valve. If further consumers are operated simultaneously, then although there is a certain drop in pressure in the priority valve, it can be kept low by means of appropriate selection of the springs of the individual pressure balances and of the priority valve. The priority valve can preferably be acted upon in one direction by the pressure of the pump and in the other direction by the maximum load pressure in the load-sensing system via the shuttle valve thereof.

It is particularly advantageous if a shut-off valve is provided with which the priority valve can be switched into the second extreme position. This prevents the lifting cylinder, if it is not to be operated, being extended by the higher load pressure of further consumers.

When the lifting cylinder is lowered, its load pressure is preferably tapped off and is used for the purpose of controlling the priority valve to move into the first extreme position of the priority valve in order to ensure that it remains in this position during the entire lowering operation irrespective of whether further consumers are actuated or not. A particularly favorable solution arises if the load-holding valve is appropriately modified and is designed for tapping off the load pressure of the lifting cylinder.

Means are preferably provided in the circuit according to the invention, which means permit a lowering of small loads if the pressure of consumers connected in the load-sensing system predominates over those of the lifting cylinder. It is therefore possible to lower minor loads without energy being recuperated. In order to recognize this particular situation, the switching means for lowering small loads can comprise a position switch which recognizes the switching position of the priority valve, or they have pressure sensors which measure the pressures in the lifting cylinder and the load pressure in the load-sensing system, in particular the maximum load pressure prevailing there. In a preferred embodiment, the measuring signals act on a load-lowering valve which, on the basis of the position signal output by the position switch or of the signals output by the pressure sensors, permits a lowering of the lifting cylinder without energy being recuperated.

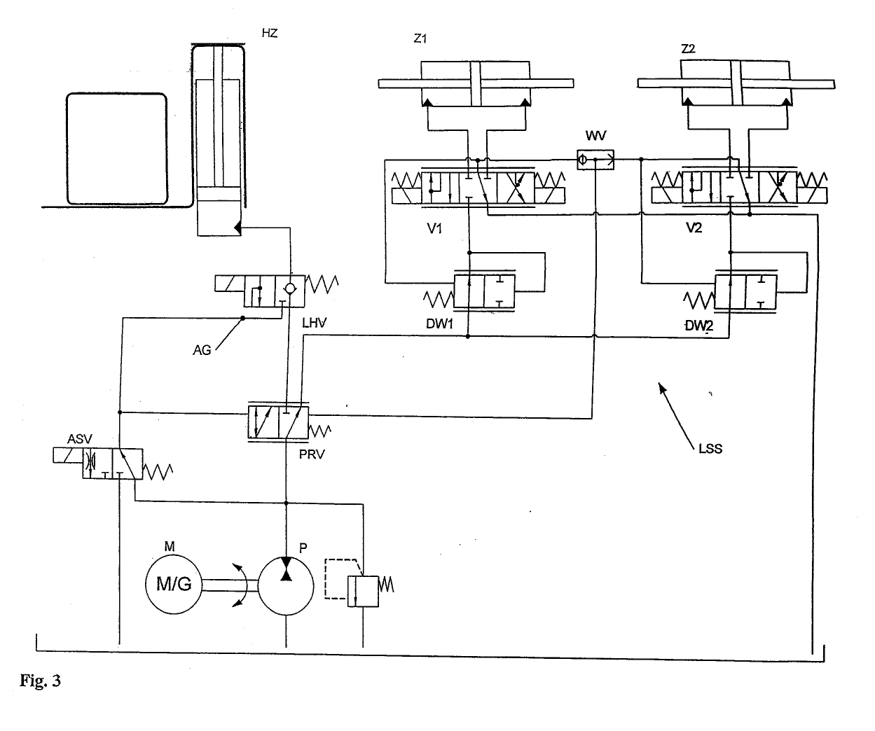

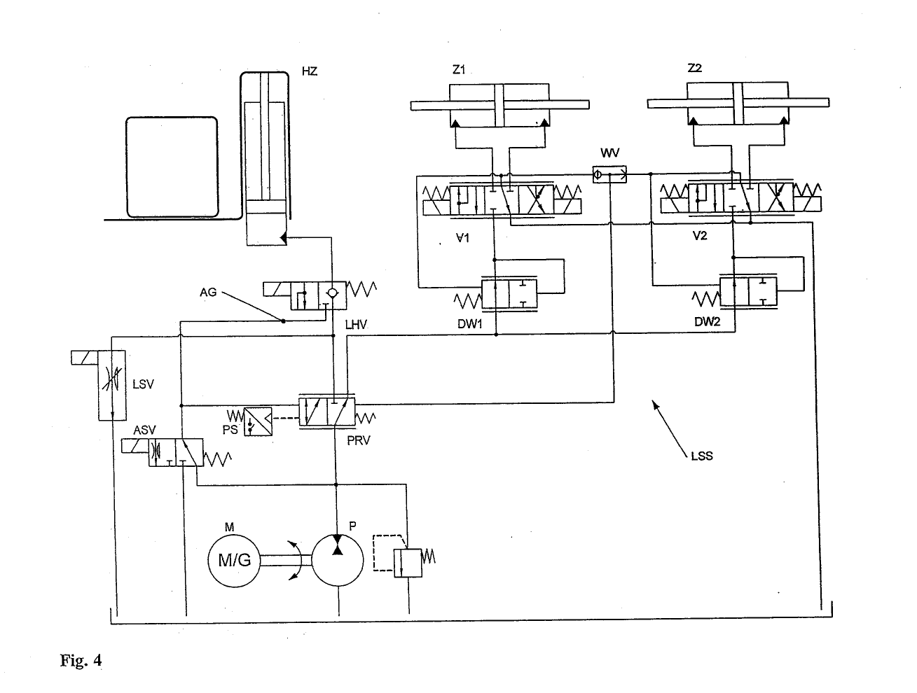

Further features and advantages of the invention emerge from the description below of the exemplary embodiments of FIGS. 3 and 4.

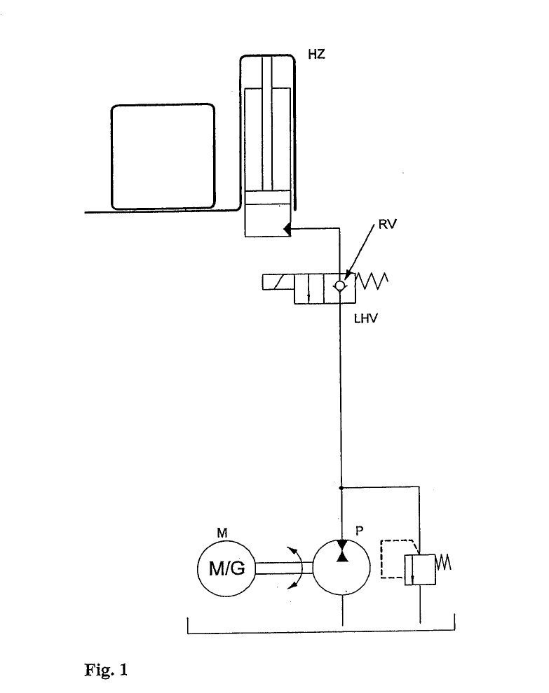

The exemplary embodiment illustrated in FIG. 3 shows the fixed displacement pump P which is driven by an electric motor M and supplies the hydraulic pressure for the lifting cylinder HZ via a load-holding valve LHV. As already described with reference to FIG. 1, in order to lower the load the load-holding valve LHV is switched electrically into its left position in which the hydraulic fluid can flow back to the pump virtually without restriction, the pump P then acting as a hydraulic motor and the electric motor M acting as a generator for recharging a battery.

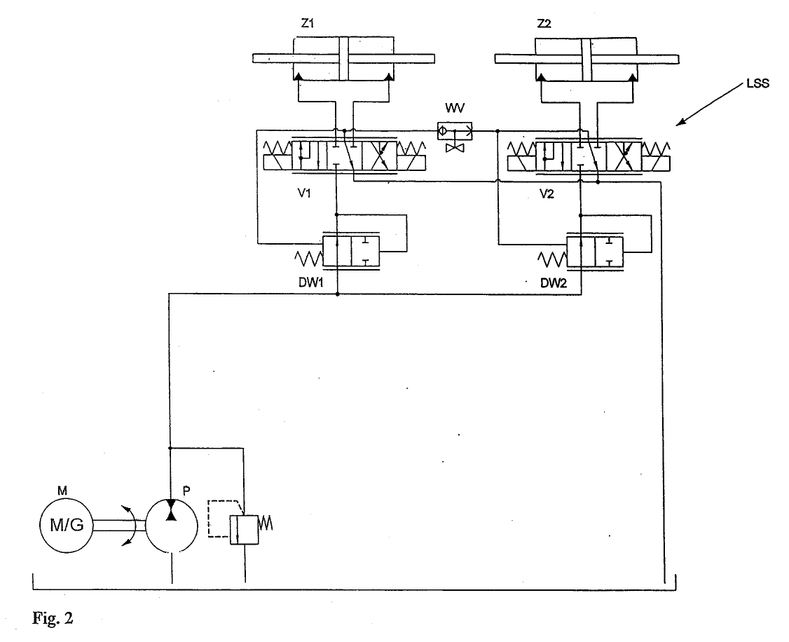

The pump P also operates a load-sensing system LSS with the further consumers Z1, Z2 which are in each case connected to the pump via individual pressure balances DW1, DW2 and directional control valves V1, V2 in the manner described in conjunction with FIG. 2. Between pump P and load-holding valve LHV there is a priority valve PRV with which these further consumers Z1, Z2 are primarily supplied. The priority valve PRV has the task of distributing, irrespective of the current pressure conditions, the volumetric flow flowing in to the lifting cylinder HZ, on the one hand, and to the further consumers, on the other hand, with minimal loss of pressure. Since the individual pressure balances DW1, DW2 control the volumetric flows to the further consumers, the remaining residue flows automatically to the lifting cylinder HZ.

The priority valve PRV is a proportional servo valve which, in the exemplary embodiment shown, is designed as a 3/2-way directional control valve. That side of the priority valve PRV which is on the left in the drawing can be connected to the working line of the pump P and can be acted upon by the pressure produced by the pump P. The priority valve PRV can therefore be adjusted in the direction of a first extreme position, in which it connects the pump P both to the lifting cylinder HZ and at least to one of the further consumers of the load-sensing system. In the opposite direction, the priority valve PRV is activated on the side illustrated on the right in FIG. 3 by the load pressure of the load-sensing system LSS, which is supplied from there via the shuttle valve WV and acts upon the priority valve PRV in the direction of its second extreme position, in which it only connects the load-sensing system to the pump P while the lifting cylinder HZ is completely cut off.

For the situation in which the lifting cylinder HZ is not to be operated, a switching-off valve ASV is provided which places the left side of the priority valve PRV to tank pressure level, so that the priority valve PRV remains in its second extreme position in which no volumetric flow can flow to the lifting cylinder HZ.

In the starting position, as described previously, the electrically activatable switching-off valve connects the working line of the pump P to the left side of the priority valve and, in the switching position, connects this left side to the tank via an almost blocked orifice. The orifice here is merely intended to ensure that an undefined residual pressure does not remain on the left side of the priority valve.

In order to recuperate energy from the lifting cylinder HZ, it is required to transfer the priority valve into its left position (first extreme position). It is intended to remain in this position during the entire lowering operation irrespective of whether the further consumers are to be actuated or not. In order to achieve this, a load tap-off AG is provided which is likewise supplied to the left side of the priority valve. In the exemplary embodiment shown, the load-holding valve LHV is modified for this purpose in such a manner that, in its “lowering” switching position, the load pressure of the lifting cylinder is tapped off at the same time. In this situation, the previously described switching-off valve ASV is in the greatly orificing position shown on the left. Since it cannot form a complete block, a very small volumetric flow thereby flows to the tank and does not contribute to the recuperation of energy. However, in view of the flow path from the lifting cylinder HZ to the pump being very substantially free from loss in pressure, this effect can be virtually disregarded.

A development of the described arrangement is illustrated in FIG. 4. It corresponds in basic principle to the previously illustrated circuit, but contains two further switching components in the form of a position switch PS and a load-lowering valve LSV. The reference numbers for the remaining circuit elements, the function of which is unchanged, have been retained.

The circuit illustrated in FIG. 4 also covers the situation in which, during lowering of a small lifting load and simultaneous operation of further consumers, the latter are at a higher pressure. In such a situation, a system with a single pump would be overtaxed. On the other hand, however, the recuperation of energy can be dispensed with here because the energy available for this purpose is in any case only very small.

Firstly, the special case described and the associated state of the system have to be recognized unequivocally. This takes place with the position switch PS. It is assigned to the priority valve PRV and recognizes when, during the lowering of the lifting cylinder HZ, the sliding member of the priority valve PLV is displaced to the left in the direction of its second extreme position. The position switch PS is assigned a load-lowering valve LSV in the form of an orificing valve which can be activated electronically and proportionally and is activated by the control system when the position switch PS gives the appropriate signal.

As an alternative to the position switch PS, pressure sensors can also be used for the same purpose, the pressure sensors measuring, on the one hand, the pressure in the lifting cylinder HZ and, on the other hand, the maximum load pressure of the consumers in the load-sensing system, the measuring signals being used, after appropriate processing, by the control system in turn in order to switch the load-lowering valve LSV.

The described circuit arrangement for a system with a lifting cylinder operated by a single motor pump and with further consumers permits an efficient recuperation of energy that is approximately comparable in terms of energy with that of systems which require at least one further pump with an inverter.

1. Hydraulic circuit arrangement with a fixed displacement pump (P) driven by an electric motor (M), and a lifting cylinder (HZ), where, in order to recuperate energy, the electric motor CM) can be operated as a generator (G) and the pump (P) can be operated as a hydraulic motor in order to recuperate potential energy of the lifting cylinder (HZ), and with a load-holding valve (LHV) arranged in the line between pump (P) and lifting cylinder (HZ), characterized
in that a priority valve (PRV) which is acted upon by the pump (P) is arranged between pump (P) and load-holding valve (LHV) and distributes the volumetric flow flowing from the pump (P) to the lifting cylinder (HZ), on the one hand, and to at least one further consumer of a load-sensing system (LSS), on the other hand,
in that, in the first of its two extreme positions, the priority valve (PRV) connects both the lifting cylinder (HZ) and the at least one further consumer in each case to the pump (P), and
in that, in the second of its two extreme positions, the priority valve (PRV) only connects the at least one further consumer to the pump (P) while the lifting cylinder (HZ) is completely cut off.

2. Hydraulic circuit arrangement according to claim 1, in which the priority valve can be acted upon in one direction by the pressure of the pump (P) and in the other direction by the maximum load pressure in the load-sensing system (LSS) via the shuttle valve (WV) thereof.

3. Hydraulic circuit arrangement according to claim 1, in which a switching-off valve (ASV) is provided with which the priority valve (PRV) can be switched into the second extreme position.

4. Hydraulic circuit arrangement according to claim 1, in which, when the lifting cylinder (HZ) is lowered, its load pressure is tapped off for the purpose of controlling the priority valve (PRV).

5. Hydraulic circuit arrangement according to claim 4, in which the load-holding valve (LHV) is designed for tapping off the load pressure of the lifting cylinder (HZ).

6. Hydraulic circuit arrangement according to claim 1, in which switching means are provided which permit small loads to be lowered when the pressure of consumers connected in the load-sensing system (LSS) predominates over that of the lifting cylinder (HZ).

7. Hydraulic circuit arrangement according to claim 6, in which the switching means for lowering small loads have a position switch (PS) which recognizes the switching position of the priority valve (PRV).

8. Hydraulic circuit arrangement according to claim 6, in which the switching means for lowering small loads have pressure sensors which measure the pressures in the lifting cylinder (HZ) and the load pressure in the load-sensing system (LSS).

9. Hydraulic switching arrangement according to claim 8, in which one of the pressure sensors measures the maximum load pressure in the load-sensing system (LSS).

10. Hydraulic circuit according to claim 6, in which the switching means for lowering small loads have a load-lowering valve (LSV) which, on the basis of the position signal output by the position switch or of the signals output by the pressure sensors, permits a lowering of the lifting cylinder without recuperating energy.
